(19) United States
(12) Patent Application Publication
(10) Pub. No.: US 2025/0153779 A1
(43) Pub. Date: May 15, 2025

(54) VEHICLE FRONT HOOD STRUCTURE

(71) Applicant: SUBARU CORPORATION, Tokyo (JP)

(72) Inventors: Yuuma YAZAKI, Tokyo (JP); Keisuke SUZUKI, Tokyo (JP); Shogo TAKAHARA, Tokyo (JP); Ryo KOROKI, Tokyo (JP)

(73) Assignee: SUBARU CORPORATION, Tokyo (JP)

(21) Appl. No.: 18/929,688

(22) Filed: Oct. 29, 2024

(30) Foreign Application Priority Data
Nov. 14, 2023 (JP) 2023-193666

(51) Int. Cl. B62D 25/10; B62D 25/12; E05B 83/24

(52) U.S. Cl. CPC B62D 25/105; B62D 25/12; E05B 83/24

(57) ABSTRACT

A vehicle front hood structure includes: a hood outer panel; a hood inner panel joined to an inner surface of the hood outer panel such that a gap is formed between the hood inner panel and the inner surface; a striker bracket that is provided on the hood inner panel and to which a striker is fixed; and a hood lock reinforcement that is disposed in the gap, faces the striker bracket from above, and is joined to the inner surface. The hood lock reinforcement includes: an upper surface part that covers an entire upper surface of the striker bracket and is joined to the hood outer panel; a leg that is provided at the upper surface part and is joined to the hood inner panel; and a beam that extends along the upper surface part, is provided on a portion facing the striker and is continuous with the leg.

### CROSS-REFERENCE TO RELATED APPLICATION

The present application claims priority from Japanese Patent Application No. 2023-193666 filed on Nov. 14, 2023, the entire contents of which are hereby incorporated by reference.

### BACKGROUND

The disclosure relates to a vehicle front hood structure.

A power unit room is provided at a front part of a vehicle such as an automobile. An upper part of the power unit room is covered with a front hood. A power unit such as an electric motor or an engine is accommodated in the power unit room. A rear part of the front hood is supported via a hinge. The front hood is openable and closable on a front part side thereof in a state in which the front hood is supported by the hinge.

The front hood includes a hood outer panel and a hood inner panel. The hood outer panel is a design surface. The hood inner panel is joined to a back surface of the hood outer panel. The hood inner panel is a stiffening member for reinforcing the hood outer panel.

A striker is fixed to a front part of the hood inner panel at a center in a vehicle width direction. A hood lock mechanism including a hook that engages with the striker is fixed to a front part of a vehicle body. When the striker is engaged with the hook, the front hood is maintained in a closed state.

In a head impact test at a development stage, a head impactor is ejected from an impact device from obliquely above the front toward a front panel. The head impactor simulates a head of a pedestrian. In the head impact test, an impact load received by the head impactor is measured, and a head injury criteria (HIC) value is evaluated.

A striker bracket for fixing the striker is fixed to the front part of the hood inner panel. The striker bracket has high rigidity. Therefore, when the head impactor collides with the striker bracket, the HIC value is increased.

### SUMMARY

An aspect of the disclosure provides a vehicle front hood structure for a vehicle. The vehicle front hood structure includes a hood outer panel of a front hood of the vehicle, a hood inner panel, a striker bracket, and a hood lock. The hood inner panel is joined to an inner surface of the hood outer panel such that a gap is formed between the hood inner panel and the inner surface of the hood outer panel. The striker bracket is provided on the hood inner panel, and a striker configured to lock a front part of a front hood to a vehicle body of the vehicle is fixed to the striker bracket. The hood lock reinforcement is disposed in the gap, faces the striker bracket from above, and is joined to the inner surface of the hood outer panel. The hood lock reinforcement includes an upper surface part, a leg, a beam. The upper surface part covers an entire upper surface of the striker bracket and is joined to the hood outer panel. The leg is provided at a front part of the upper surface part and is joined to the hood inner panel. The beam extends from a front end to a rear end of the upper surface part, is provided on a portion facing the striker and is continuous with the leg.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is an external diagram of a vehicle in which a hood lock reinforcement is provided on a front hood.

FIG. 2 is a plan view of the front hood in which a hood outer panel is removed.

FIG. 3 is an enlarged view of a main part in FIG. 2.

FIG. 4 is a perspective view of a main part of the front hood in which the hood outer panel is removed.

FIG. 5A is a side cross-sectional view of the front hood at a center in a vehicle width direction in FIG. 1.

FIG. 5B is a cross-sectional view corresponding to FIG. 5A and illustrating a state in which a head impactor collides with the front hood.

FIG. 5C is a cross-sectional view corresponding to FIG. 5A and illustrating a state in which an upper legform impactor collides with the front hood.

### DETAILED DESCRIPTION

In one example, a center part in a vehicle width direction at a front part of a front hood in which a striker is disposed has low rigidity, and it is necessary to stiffen the center part in order to reduce a HIC value. For example, Japanese Unexamined Patent Application Publication (JP-A) No. 2023-57237 discloses a technique of adhering a hood lock reinforcement to an inner surface of a hood outer panel facing a striker bracket. According to the technique disclosed in this document, when a head impactor collides with the center part in the vehicle width direction at the front part of the front hood, deformation of the hood lock reinforcement secures a drag, and the HIC value can be reduced.

An upper legform impact test is also performed at a development stage. In the upper legform impact test, an upper legform impactor in a state of being inclined forward at a predetermined angle is ejected from an impact device toward an upper part of a front end of a vehicle body.

The upper legform impactor simulates an upper leg of a pedestrian. In the upper legform impact test, an impact load that is received when the upper legform impactor collides with the vehicle body is measured to check whether an injury value satisfies a reference value.

In the related art, as a structure that generates a drag in a vehicle body on a side receiving an impact from the upper legform impactor, one the following two structures is often employed.
1) The upper legform impactor collides with a bumper instead of colliding with the front hood, and the drag is secured by an internal structure of the bumper.
2) The upper legform impactor collides with the front hood, and the drag is secured by deformation of the front hood.

As compared with the structure in 1), the structure in 2) has an advantage of having a high degree of freedom in design. With the structure in (2), when the upper legform impactor collides with the front hood, a sufficient drag can be secured as long as the front hood can be crushed toward a rear of the vehicle body with a large stroke.

In a state in which the front hood is closed, the striker is engaged with and locked to the hook of the hood lock mechanism. The striker bracket for holding the striker has high rigidity. Therefore, it is necessary to make such a design that the impact load received by the upper legform impactor is absorbed before contact with the striker bracket occurs.

In this case, the hood outer panel serves as a design surface. Therefore, when it attempts to adjust a drag against the impact load from the upper legform impactor by deformation of the hood outer panel, designability tends to be impaired and is difficult to attain.

A hood inner panel is provided in a protruding ridge shape to secure rigidity. The protruding ridge shape of the hood inner panel is provided to reinforce the hood outer panel. Therefore, the shape of the hood inner panel is also limited in design. In order to satisfy flexural rigidity in a front-rear direction of the vehicle body, strict formability is necessary due to the shape of the hood inner panel. Due to the formation of the hood inner panel, it is also difficult to finely adjust the drag against the load received from the upper legform impactor in the front-rear direction.

It is also considered to absorb the impact load received by the upper legform impactor by the deformation of the hood lock reinforcement disclosed in JP-A No. 2023-57237. However, the hood lock reinforcement disclosed in JP-A No. 2023-57237 is simply adhered to the inner surface of the hood outer panel. Therefore, a drag for absorbing the impact load from the head impactor may be generated. However, it is difficult to secure a drag for absorbing the impact load from the upper legform impactor that collides with a front part of the vehicle body from obliquely above.

It is desirable to provide a vehicle front hood structure capable of securing a drag that is necessary to absorb an impact load from an upper legform impactor before contact with a striker bracket occurs.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

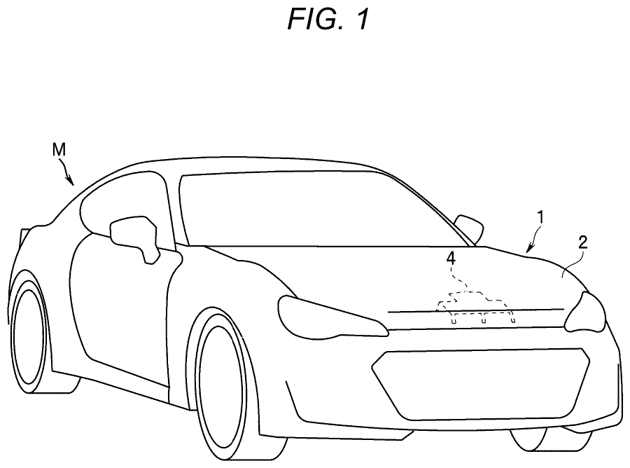

As illustrated in FIG. 1, a front hood 1 is provided at a front part of a vehicle M. The front hood 1 covers an upper part of a power unit room provided in the front part of the vehicle M. A rear part of the front hood 1 is supported on a vehicle body via a hinge (not illustrated). A front part of the front hood 1 is openable and closable in a state in which the rear part is supported by the hinge. A front end of the front hood 1 faces a position substantially the same as that of a front surface of a front grille (not illustrated).

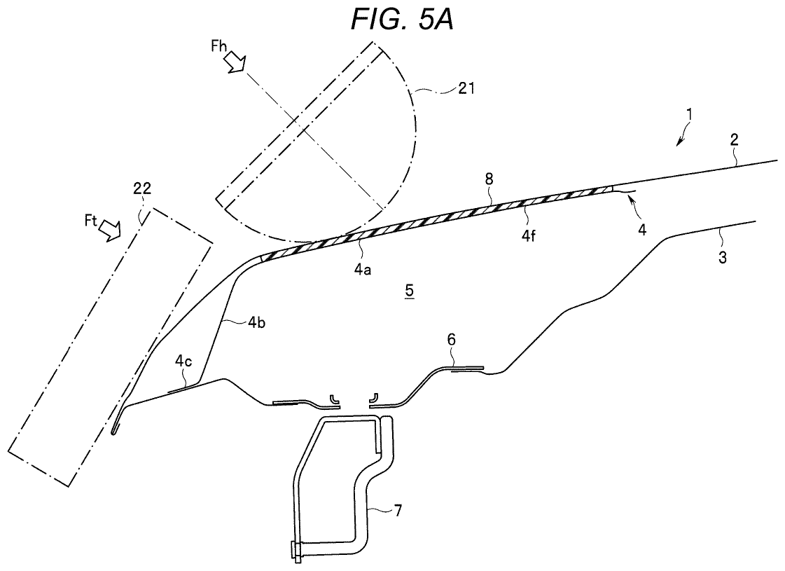

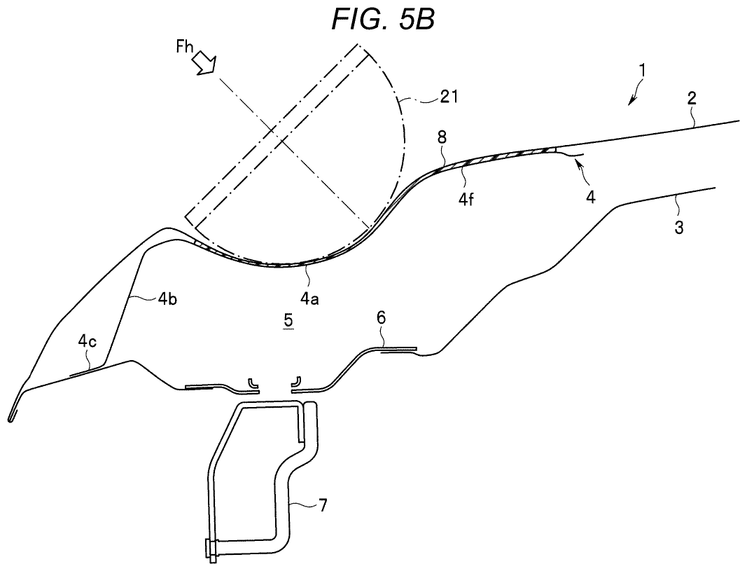

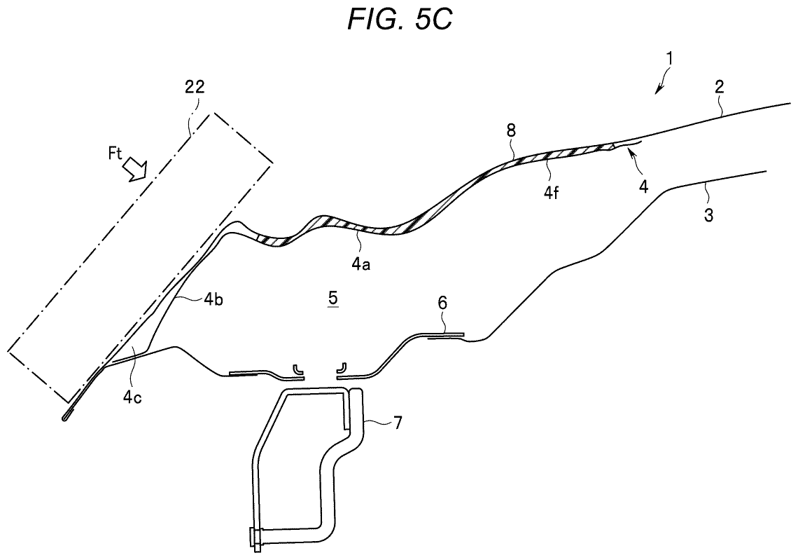

As illustrated in FIG. 5A, the front hood 1 includes a hood outer panel 2, a hood inner panel 3, and a hood lock reinforcement 4. The hood outer panel 2 serves as a design surface. The hood inner panel 3 is a reinforcing member for reinforcing the hood outer panel 2.

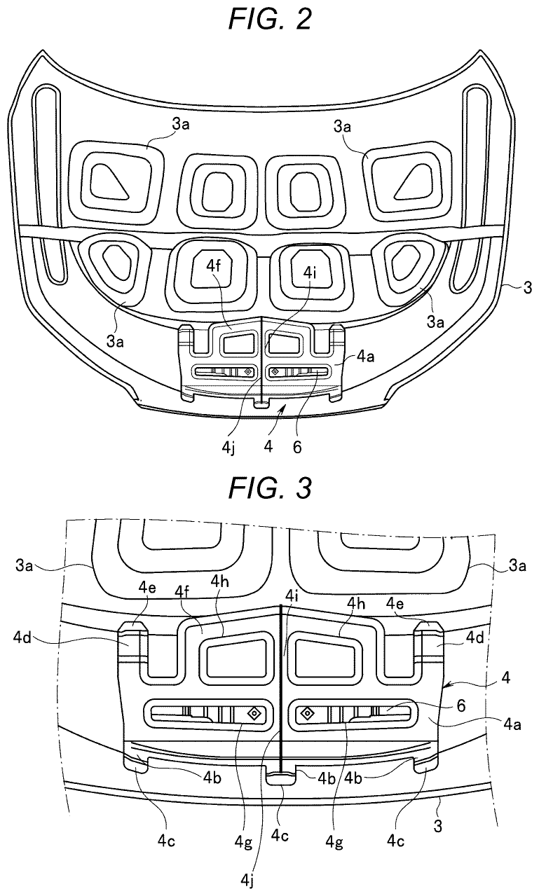

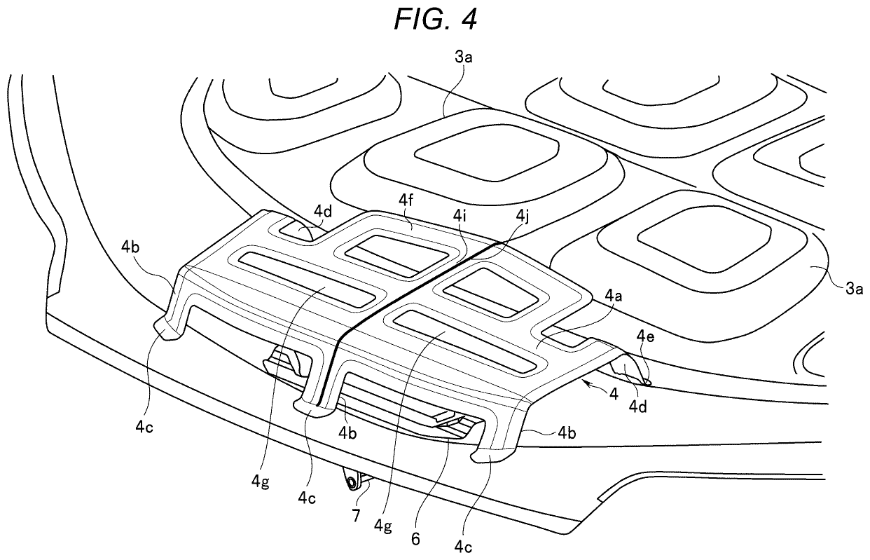

As illustrated in FIGS. 2 to 4, the hood inner panel 3 has ridge-shaped protrusions 3a at predetermined intervals. An upper surface of each of the protrusions 3a is joined to an inner surface of the hood outer panel 2 by spot welding, adhesion using an adhesive, or the like. Further, a peripheral edge of the hood outer panel 2 and a peripheral edge of the hood inner panel 3 are coupled to each other by a hemming process. A gap 5 is formed between the hood outer panel 2 and the hood inner panel 3 by the protrusion 3a.

A striker bracket 6 is joined to a center in the vehicle width direction of the hood inner panel 3, which is at the front part of the vehicle, by spot welding, screwing, or the like. A striker 7 is fixed to the center of the striker bracket 6 in the vehicle width direction. The striker bracket 6 has a shape slightly oblong in the vehicle width direction. The striker bracket 6 is a stiffening member for reinforcing the vicinity of the striker 7. Therefore, the striker bracket 6 has high rigidity.

A hood lock mechanism (not illustrated) is fixed to a front part of the vehicle body. The hood lock mechanism is fixed, for example, to a radiator upper panel. In a state in which the front hood 1 covers the upper part of the power unit room, the striker 7 is engaged with a hook of the hood lock mechanism. When the striker 7 is engaged with the hook, the front part of the front hood 1 is locked to the vehicle body.

The hood lock reinforcement 4 faces the striker bracket 6 from above. The hood lock reinforcement 4 is interposed in the gap 5 between the hood outer panel 2 and the hood inner panel 3. The hood lock reinforcement 4 is made of sheet metal obtained by processing a metal plate such as a steel plate and an aluminum plate.

As illustrated in FIGS. 2 to 4 and 5A, an upper surface part 4a of the hood lock reinforcement 4 has a shape of covering an entire upper surface of the striker bracket 6. A center of the hood lock reinforcement 4 in the vehicle width direction is located above the striker 7.

Front legs 4b are provided at a front end of the upper surface part 4a of the hood lock reinforcement 4. The front legs 4b are bent downward from three positions that are located at a center part and two ends of the upper surface part 4a. Further, a flange 4c is provided at a lower end of each of the front legs 4b. The flange 4c is bent forward from the lower end of the front leg 4b.

Rear legs 4d are provided at a rear end of the upper surface part 4a of the hood lock reinforcement 4. The rear legs 4d are bent downward from two ends of the rear end of the upper surface part 4a. A flange 4e is provided at a lower end of each of the rear legs 4d. The flange 4e is bent rearward from the lower end of the rear leg 4d.

The front legs 4b at a front side and the rear legs 4d at a rear side are disposed in the front-rear direction across the striker bracket 6. Further, the flange 4c provided on the front leg 4b is joined to the hood inner panel 3 in front of the striker bracket 6. On the other hand, the flange 4e provided on the rear leg 4d is joined to the hood inner panel 3 behind the striker bracket 6.

A rear extension 4f is provided that is integrated with the upper surface part 4a of the hood lock reinforcement 4. The rear extension 4f extends rearward from between left and right rear legs 4d provided at the rear end of the upper surface part 4a. Openings 4g and openings 4h are provided in the upper surface part 4a and the rear extension 4f, respectively. The openings 4g and openings 4h are both provided at positions that are laterally symmetrical about the center in the vehicle width direction.

Further, a beam 4i is provided on the upper surface part 4a and the rear extension 4f. The beam 4i is provided at the center in the vehicle width direction between the openings 4g and 4h. The beam 4i is continuous with the front leg 4b at the center in the vehicle width direction. A bead (rib) 4j is provided on the beam 4i and the front leg 4b at the center in the vehicle width direction. The bead 4j is provided at the center in the vehicle width direction of the beam 4i and the front leg 4b at the center of the front part. The bead 4j is provided in a linear shape from the front part to the rear part over the beam 4i and the front leg 4b at the center in the vehicle width direction. A cross section of the bead 4j has, for example, a recessed shape.

The upper surface part 4a and the rear extension 4f are joined to the inner surface of the hood outer panel 2 through an adhesive 8. A reference numeral 21 denotes a head impactor, and a reference numeral 22 denotes an upper legform impactor. The head impactor 21 simulates a head of a pedestrian. The upper legform impactor 22 simulates an upper leg of a pedestrian.

Next, an operation of the front hood structure having such a configuration will be described.

### Head Impact Test

In the head impact test, an impact device ejects the head impactor 21 from obliquely above the front toward the front part of the front hood 1 at the center in the vehicle width direction. Then, as illustrated in FIG. 5B, the upper surface part 4a of the hood lock reinforcement 4, which is adhered to an inner side of the hood inner panel 3 via the adhesive 8, deforms together with the hood outer panel 2.

The deformation of the upper surface part 4a of the hood lock reinforcement 4 is gradually increased by an inertial mass when the head impactor 21 collides with the hood outer panel 2. When the upper surface part 4a of the hood lock reinforcement 4 deforms, a drag is generated to absorb an impact load Fh received by the head impactor 21. The hood outer panel is the design surface, and a drag characteristic against the impact load is hardly considered.

On the hood lock reinforcement 4, the front legs 4b and the rear legs 4d are provided at the front and rear ends of the upper surface part 4a. The flanges 4c and 4e that are bent at the lower ends of the front legs 4b and the rear legs 4d are joined to the hood inner panel 3. The drag characteristic of the hood lock reinforcement 4 against the collision of the head impactor 21 is adjusted according to the shape or the number of the openings 4g and 4h and lateral widths of the front legs 4b and the rear legs 4d.

By the adjustment so as to obtain an optimum drag characteristic, the impact load Fh received by the head impactor 21 is absorbed before the upper surface part 4a of the hood lock reinforcement 4 comes into contact with the striker bracket 6.

In one example, the flanges 4c and 4e of the front legs 4b and the rear legs 4d of the hood lock reinforcement 4 are joined to the hood inner panel 3. Therefore, without modifying the hood outer panel 2 serving as the design surface, the optimum drag characteristic can be obtained by simply changing the shape of the hood lock reinforcement 4. Accordingly, an HIC value can be reduced.

The hood lock reinforcement 4 stiffens the center part in the vehicle width direction at the front part of the front hood 1. Accordingly, when the center part is lightly hit by a hand, an elbow, or the like of a pedestrian or the like, recession of the center part can be prevented in advance.

### Upper Legform Impact Test

In the upper legform impact test, the impact device ejects the upper legform impactor 22 from obliquely above the front of the vehicle M downward toward the center of the front end of the front hood 1 in the vehicle width direction. A reason why the impact device ejects the upper legform impactor from obliquely above the front of the vehicle M downward will be briefly described. When a leg of a pedestrian collides with the front part of the vehicle M, the leg is scooped up by a bumper or the front grille. Then, an upper body of the pedestrian falls down toward the front hood 1. At this time, an upper leg of the pedestrian falls down from obliquely above the front of the vehicle M to the front end of the front hood 1. The impact device simulates this and ejects the upper legform impactor.

When the upper legform impactor 22 collides with the center of the front end of the front hood 1 in the vehicle width direction, a front end of the hood outer panel 2 is bent downward by an impact load Ft from the upper legform impactor 22, as illustrated in FIG. 5C. Subsequently, the front end of the hood outer panel 2 that receives the impact load Ft from the upper legform impactor 22 presses against a front part of the hood lock reinforcement 4.

The front leg 4b is provided at the center of the front part of the hood lock reinforcement 4. The front leg 4b at the center of the front part receives the impact load Ft from the upper legform impactor 22 and is pressed toward the rear of the vehicle body.

The flange 4c that is bent at the lower end of the front leg 4b at the center of the front part is joined to the hood inner panel 3. The upper surface part 4a, which is continuous with the front leg 4b, is adhered to the hood inner panel 3. Since the front leg 4b at the center of the front part receives the impact load Ft from the upper legform impactor 22, an initial drag can be increased.

The front leg 4b at the center of the front part is linearly continuous with the beam 4i provided on the upper surface part 4a of the hood lock reinforcement 4. The hood outer panel 2 adhered to the beam 4i and the upper surface part 4a receives the impact load Ft from the upper legform impactor 22 and is crushed. The impact load Ft from the upper legform impactor 22 is absorbed by a drag generated by crushing the beam 4i and the upper surface part 4a.

The bead 4j is provided on the front leg 4b at the center of the front part and the beam 41. The drag characteristic of the hood lock reinforcement 4 against the impact load Ft from the upper legform impactor 22 is adjusted according to widths of the front leg 4b at the center of the front part and the beam 4i, and the shape of the bead 4j. When the hood lock reinforcement 4 receives the impact load Ft from the upper legform impactor 22, the front leg 4b at the center of the front part and the beam 4i are crushed and the drag is generated. By adjusting the drag, the front leg 4b at the center of the front part absorbs the impact load Ft from the upper legform impactor 22 before reaching a front end of the striker bracket 6. Accordingly, an injury value evaluated based on the load applied to the upper legform impactor 22 is made equal to or smaller than a reference value.

In this manner, in the present embodiment, the impact load Ft from the upper legform impactor 22 is absorbed by crushing the hood lock reinforcement 4 provided in the front hood 1. When the upper legform impactor 22 collides with the center of the front part of the front hood 1 from the front, the impact load Ft is received by the front leg 4b, which is provided at the center of the front part of the hood lock reinforcement 4.

The flange 4c provided at the lower end of the front leg 4b is joined to the hood inner panel 3. Therefore, the front leg 4b at the center of the front part receives the impact load Ft from the upper legform impactor 22, so that the initial drag can be increased.

The beam 4i is provided at the center of the upper surface part 4a and the rear extension 4f of the hood lock reinforcement 4 in the vehicle width direction, and the bead 4j is provided on the beam 4i. By adjusting the width of the beam 4i and the shape of the bead 4j, the drag characteristic obtained by crushing of the hood lock reinforcement 4 against the impact load Ft from the upper legform impactor 22 can be adjusted to an optimum value. As a result, it is easy to secure the drag that is necessary to absorb the impact load Ft from the upper legform impactor 22 before the hood lock reinforcement 4 comes into contact with the striker bracket 6.

By providing the hood lock reinforcement 4 above the striker bracket 6 according to the present embodiment, frame rigidity of the front part of the front hood 1 is improved. As a result, the striker 7 provided on the front hood 1 can be accurately engaged with the hook provided on the hood lock mechanism, which is fixed to the front part of the vehicle body.

The disclosure is not limited to the embodiment described above. For example, the bead 4j provided on the beam 4i of the hood lock reinforcement 4 may be provided simply on the beam 41 of the upper surface part 4a and the rear extension 4f. The bead 4j may not be provided on the hood lock reinforcement 4. In this case, the drag for absorbing the impact load Ft from the upper legform impactor 22 is adjusted by the width of the beam 41.

Further, when a necessary drag against the impact load can be secured by the upper surface part 4a alone, the rear extension 4f can be omitted.

According to the disclosure, the hood lock reinforcement includes the upper surface part, the legs, and the beam. The upper surface part covers the entire upper surface of the striker bracket and is joined to the hood outer panel. The legs are provided at the front part of the upper surface part and are joined to the hood inner panel. The beam extends from the front end to the rear end of the upper surface part, and is provided in a portion facing the striker and is continuous with the legs. Thus, the shape of the beam facilitates adjusting of the drag for absorbing the impact load from the upper legform impactor. As a result, due to the crushing of the hood lock reinforcement, a necessary drag can be secured before contact with the striker bracket occurs.

1. A vehicle front hood structure for a vehicle, the vehicle front hood structure comprising:
a hood outer panel of a front hood of the vehicle;
a hood inner panel that is joined to an inner surface of the hood outer panel such that a gap is formed between the hood inner panel and the inner surface of the hood outer panel;
a striker bracket that is provided on the hood inner panel and to which a striker configured to lock a front part of a front hood to a vehicle body of the vehicle is fixed; and
a hood lock reinforcement that is disposed in the gap, faces the striker bracket from above, and is joined to the inner surface of the hood outer panel, wherein
the hood lock reinforcement comprises
an upper surface part that covers an entire upper surface of the striker bracket and is joined to the hood outer panel,
a leg that is provided at a front part of the upper surface part and is joined to the hood inner panel, and
a beam that extends from a front end to a rear end of the upper surface part, is provided on a portion facing the striker and is continuous with the leg.

2. The vehicle front hood structure according to claim 1, wherein
openings are provided in the upper surface part on left and right sides in a vehicle width direction, and
the beam is provided between the openings.

3. The vehicle front hood structure according to claim 1, wherein
a bead is provided on the beam, the bead extending along the beam.

4. The vehicle front hood structure according to claim 1, wherein
a bead is provided that is continuously formed on the beam and the leg, the bead extending along the beam and the leg.

5. The vehicle front hood structure according to claim 1, wherein
a rear extension is provided that is integrated with the rear end of the upper surface part, and
the rear extension is joined to the inner surface of the hood outer panel, and the beam provided on the upper surface part is continuously formed on the rear extension.

6. The vehicle front hood structure according to claim 2, wherein
a rear extension is provided that is integrated with the rear end of the upper surface part, and
the rear extension is joined to the inner surface of the hood outer panel, and the beam provided on the upper surface part is continuously formed on the rear extension.

7. The vehicle front hood structure according to claim 3, wherein
a rear extension is provided that is integrated with the rear end of the upper surface part, and
the rear extension is joined to the inner surface of the hood outer panel, and the beam provided on the upper surface part is continuously formed on the rear extension.

8. The vehicle front hood structure according to claim 4, wherein
a rear extension is provided that is integrated with the rear end of the upper surface part, and
the rear extension is joined to the inner surface of the hood outer panel, and the beam provided on the upper surface part is continuously formed on the rear extension.
